(19) United States
(12) Patent Application Publication
(10) Pub. No.: US 2017/0103224 A1
(43) Pub. Date: Apr. 13, 2017

(54) Method and System for Providing Secure Access and Data Storage to Mobile Computing Devices

(71) Applicant: Lieyu Hu, Bedford, MA (US)

(72) Inventor: Lieyu Hu, Bedford, MA (US)

(21) Appl. No.: 15/068,979

(22) Filed: Mar. 14, 2016

Related U.S. Application Data
(60) Provisional application No. 62/238,656, filed on Oct. 7, 2015.

(51) Int. Cl. G06F 21/62

(52) U.S. Cl. CPC G06F 21/6218

(57) ABSTRACT

Described herein are method and system for providing secure access and data storage to mobile computing devices utilizing wireless connection. A personal data storage device stores and provides identity tag and owner's data. A physically separated mobile computing device reads and validates the identity tag from the personal data storage device; upon validation, grants access to operate the mobile computing device; upon validation, grants the mobile computing device access to read data from and write data to the personal data storage device. The establishment of the wireless connection requires concurrent physical presence of both devices within a predetermined proximity.

### CROSS-REFERENCE TO RELATED APPLICATION

The application claims the priority date of Provisional application No. 62/238,656 filed on Oct. 7, 2015.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

This application relates generally to method and system of utilizing short range wireless connection to provide secure access and data storage to mobile computing devices, such as a smart phone.

### BACKGROUND OF THE INVENTION

Mobile computing devices, such as smart phones and tablets, have become immensely popular. As of 2015, there are about two billion smart phone users worldwide, and this number is projected to increase in the future.

Mobile computing devices provide access to information and financial transactions anytime and anywhere. Data stored on such devices can be important to owner's identity, finance, privacy, or family memories and needs to be secured.

There are many threats to data security of mobile computing devices, such as cyber hacking, wireless data interception, and lost or stolen of device. Currently, most data security solutions focused on anti-hacking or data encryption. There are also a few solutions for lost or stolen devices. One example is “Find My iPhone”, which backs up owner's data on a cloud server and can remotely destroy the data on the device upon owner's request.

However, the current solutions are inadequate at most, especially when the physical security of the data is concerned. The data security of cloud service is highly questionable. In 2014, iCloud data breaches had led to the leak of several celebrities' private photos. More importantly, a stolen device cannot be remotely wiped clean if the device was taken off the wireless network. Another often overlooked security breach for many current smart phones is that a third party can receive calls, reply text messages when the phone screen was locked and protected by a password. This security breach can potentially cause catastrophic damage to owner's reputation, relationship, or career.

Clearly, there is an unmet need for the present invention, providing enhanced protection to owner's identity, data, and the access to the mobile computing device.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an embodiment of the present invention; and

FIG. 2 is a flow diagram illustrating one embodiment of the operation of the present invention.

Unless otherwise indicated illustrations in the figures are not necessarily drawn to scale.

### SUMMARY OF THE INVENTION

The present invention is described as a communication system comprised of a mobile computing device (MCD), a personal data storage device (PDSD), and communication circuitries embedded in both devices that can wirelessly connect both devices. The MSD can be a smart phone, a tablet, or a laptop. The PSDS can be an implant or a personal wearable item, such as a ring, a pendent, or a watch. The wireless connection can be established using near-field communication (NFC) technology, Bluetooth technology, infrared technology, or a combination of multiple technologies. For simplicity and not by way of limitation, a smart phone is used as an example for MCD; a ring is used as an example for PSDS; and the NFC is used as an example for wireless connection technology. The smart phone possesses an identity tag but does not store owner's data. The ring stores its own identity tag and the owner's data. The smart phone intermittently or constantly scans for the ring using the embedded NFC circuitry. When the ring is out of predetermined proximity, the smart phone shall not function and have no access to owner's data. When the ring is within the predetermined proximity, a wireless connection is established utilizing the NFC circuitries embedded in both devices. Through the wireless connection, the smart phone compares tags information from both devices. When the tags information matches the status when the two devices were initially paired, the phone is authorized to function and granted access to owner's data stored in the ring.

The present invention addresses the aforementioned unmet need and greatly enhances the data security and the device access control in five aspects: 1) data is stored in a device that the owner do not remove from his/herself frequently, thus reduces the probability of lost; 2) the personal data storage device (PSDS) is in disguise; its form and location is undisclosed to a third party; thus reduces the chance of theft; 3) the smart phone shall not function without the ring being in proximity; No access to the smart phone shall be granted if a third party only obtained the possession of the smart phone; 4) the wireless connection only broadcasts signals in a short range; signal interception is difficult since it has to take place in close proximity of the owner; 5) the smart phone does not contain important data or any data if configured so. In the simplest way, the smart phone itself cannot function, has no access to owner's data, and becomes disposable without being near the owner who wears the ring.

This invention relates to a scenario where a smart phone is stolen, no access to the phone is granted at all; owner's data stays with the owner; the owner regains access to the data by obtaining and re-paring a new smart phone with the ring.

This invention relates to a scenario where the owner forgets owner's smart phone as he/she leaves a restaurant; as the owner walks out of a predetermined proximity, the ring vibrates in a preprogrammed pattern, reminding the owner that he/she forgets his/her smart phone.

This invention relates to a scenario where the owner temporarily walks away from owner's smart phone; a text message is being sent to owner; the smart phone does not display the incoming text message on the lock screen till the ring wearing owner is back within proximity. No third party can read or reply the text message in the absence of the owner.

This invention relates to a scenario where a hacker organization plans to steal owner's data by attempting to pair owner's stolen smart phone to owner's ring at a close proximity. No data access is granted to the stolen smart phone since the ring is now paired with a new smart phone containing a different identity tag.

This invention relates to a scenario where a ring is stolen and a third party try to pair the ring to a new smart phone, the ring requires identity verification (passcode, password, finger print, or secret question, etc.) for pairing. No access to the data stored in the ring is granted without verification of owner's identity.

This invention relates to a scenario where a criminal organization kidnaps the owner for extremely valuable data; the owner can choose to protect the data by secretly hiding the ring, physically destroying the ring, or discarding the ring.

In a preferred embodiment, a communication system includes a smart phone with no internal storage memory and a ring; the required proximity is set at one meter utilizing appropriate wireless circuitries.

In another preferred embodiment, a communication system includes a smart phone with internal storage memory and a ring; the required proximity is set at one meter utilizing appropriate wireless circuitries. The smart phone is configured to store important data in the ring and other data in the smart phone's internal storage memory.

In another preferred embodiment, a communication system includes a smart phone with no internal storage memory and a personal data storage device in the physical form of a watch; the required proximity is set at one meter utilizing appropriate wireless circuitries. The watch has a display screen and a controlling knob or multiple knobs. The watch can run its own software applications. The watch can be operated via a controlling knob or multiple knobs. The watch can display information from itself and the smart phone. The watch can interact with the smart phone.

In another embodiment, a communication system includes a smart phone with no internal storage memory and a ring; the required proximity is configured as a three-tier structure utilizing appropriate wireless circuitries: tier one is set at fifteen centimeter for the phone to accept operation commands; tier two is set at two meter for continuous functioning of the phone; tier three is set at ten meters for the ring to vibrate and signal the owner forgets his/her phone. In this case, the ring bearing hand is preferred to hold the phone when the owner is operating the phone.

In another embodiment, a communication system includes a smart phone with internal storage memory and an implant as personal data storage device; the required proximity is set at one meter utilizing appropriate wireless circuitries.

In another embodiment, a communication system includes a compatible conventional smart phone and a ring; the required proximity is set at one meter utilizing appropriate wireless circuitries. The ring can function as access control to the smart phone. The compatible smart phone is configured to store important data in the ring and other data in its internal storage memory.

In a preferred embodiment, a communication system includes a smart phone with no internal storage memory and a ring; the rings can also be paired, provide access control to, and share data with multiple other devices, such as tablet, laptop computers. The required proximity is set at one meter utilizing appropriate wireless circuitries.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

Other features, advantages, and objects of the present invention will become more apparent and be more readily understood from the following detailed description, which should be read in conjunction with the accompanying drawings. One skilled in the art will realize the invention may be embodied in other specific forms without departing from the spirit or essential characteristics thereof. The foregoing embodiments are therefore to be considered in all respects illustrative rather than limiting of the invention described herein.

### DETAILED DESCRIPTION

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. Also, singular words should be read as plural and vice versa and masculine as feminine and vice versa, where appropriate, and alternative embodiments do not necessarily imply that the two are mutually exclusive.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

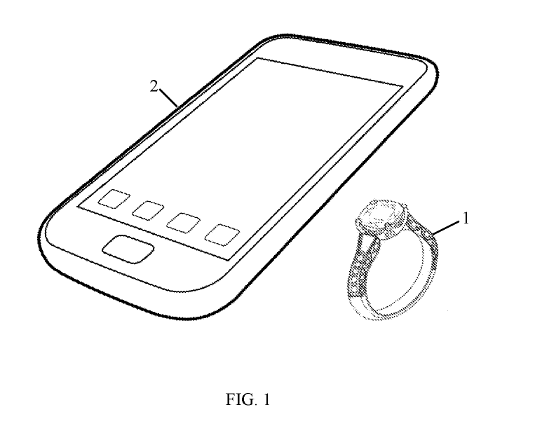

FIG. 1 shows an embodiment of the present invention comprising a ring 1 as an embodiment of personal data storage device (PSDS) and a smart phone 2 as an embodiment of mobile computing device (MSD).

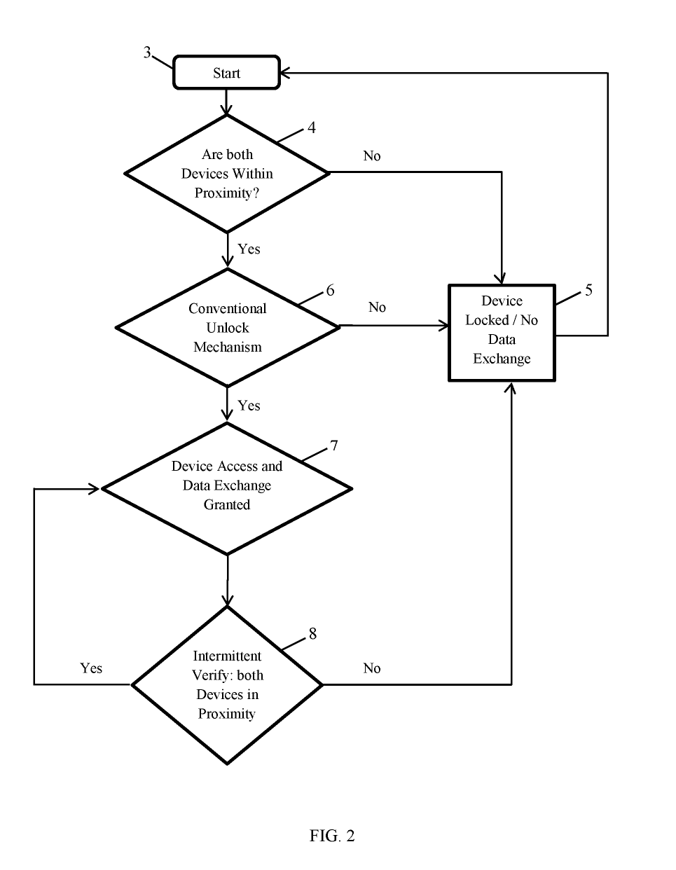

FIG. 2 illustrates one embodiment of the operation of the present invention. When mobile computing device (MSD) 2 is started, or being activated from its locked, stand-by, or hibernation states (block 3), MSD 2 scan and determine whether personal data storage device (PSDS) 1 is within a predetermined proximity (block 4). If MSD 2 determines that PSDS 1 is not within the predetermined proximity, MSD 2 remains locked and no data exchange between PSDS 1 and MSD 2 is granted (block 5). If MSD 2 determines that PSDS 1 is within the predetermined proximity, owner can proceed to unlock the MSD 2 using conventional unlocking mechanism (block 6), such as passcode, password, picture password, facial recognition, finger print, etc. Upon successful conventional unlocking, full access to operating MSD 2 and data exchange between MSD 2 and PSDS 1 are granted (block 7). MSD 2 reads and stores owner's data on PSDS 1. During the operation, MSD 2 intermittently or constantly verifies whether PSDS 1 is still within the predetermined proximity (block 8). If yes, operation of MSD 2 and data exchange with PSDS 1 continues (block 7). If PSDS 1 is not within the predetermined proximity for any reason, MSD 2 locks itself and data exchange with PSDS 1 stops (block 5). To regain access to MSD 2 and the data stored on PSDS 1, bring both devices within the predetermined proximity and re-start the operation process (block 3).

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method for providing secure access and data storage to a mobile computing device utilizing a wireless data connection, the method comprising: providing, by a personal data storage device (PDSD), identity tag information and data storage to a mobile computing device (MCD); receiving, by the mobile computing device, identity tag information and data; requiring, by the functioning of the mobile computing device and establishment of wireless connection, the concurrent physical presence of both devices within predetermined proximity of each other throughout the duration of operation, wherein:
secure access includes but not limited to verifying identity tag information to gain access to the functionality of the mobile computing device.
data includes but not limited to online account usernames, online account passwords, Microsoft office files, audio files, video files, software, and other user generated digital files and information.
wireless connection can be established based on one or multiple wireless communication technologies. Examples include but not limited to near-field communication (NFC), Bluetooth, infrared, and radio frequency identification (RFID), and other future wireless connection protocols and technologies.
personal data storage device (PDSD) is physically separated from mobile computing device (MCD) and can provide both secure access and data storage or only secure access to MCD.
mobile computing device (MCD) includes but not limited to cellular phones, smart phones, tablet computers, laptop computers.

2. The method of in claim 1, wherein the access control can be configured as a tiered or program specific structure.

3. The method of in claim 1, wherein the wireless connection can be configured as encrypted or non-encrypted.

4. The method of in claim 1, wherein the personal data storage device (PDSD) can be a personal wearable item with undisclosed physical form and location or an implant with undisclosed location.

5. The method of in claim 1, wherein the mobile computing device (MCD) can be configured to store all data, part of data, or no data on the personal data storage device (PDSD), wherein:
data can be protected using conventional data protection methods. Examples include but not limited to passcode, password, picture password, facial recognition, finger print, or identity verification questions.

6. The method of in claim 1, wherein the mobile computing device (MCP) can be configured to cache portion of data from the personal data storage device (PDSD) to its internal storage memory to facilitate data processing. Such cached data shall be destroyed at the end of usage.

7. The method of in claim 1, wherein the predetermined proximity ranges from being in physical contact to 100 meters and can be configured as a single or a tiered structure utilizing appropriate wireless circuitries. For example, the predetermined proximity can be configured as a three-tier structure: tier one is set at fifteen centimeter for the phone to accept operation commands; tier two is set at two meter for continuous functioning of the phone; tier three is set at ten meters for the ring to vibrate and signal the owner forgets his/her phone.

8. The method of in claim 1, wherein the functioning of mobile computing device (MCP) refers to accessing data stored on the personal data storage device (PDSD) and other activities typically conducted on a mobile computing device (MCP), such activities includes but not limited to making and receiving phone call, review and compose emails or text messages, access to calendar, access to address book, access to applications, conducting online financial transactions, posting messages online.

9. A system for providing secure access and data storage to a mobile computing device utilizing wireless connection, the system comprising a personal data storage device (PDSD) configured to: store device identity tag and owner's data;
and a mobile computing device (MCD) configured to: scan the presence and receive identity tag from the personal data storage device (PDSD) via wireless connection; read data from and write data to the personal data storage device (PDSD) via wireless connection. The wireless connection can only be established when both devices are in predetermined proximity to each other using wireless communication circuitry embedded in both devices, the secure access and data exchange to the mobile computing device (MCD) requires intermittent verification of both devices remaining within predetermined proximity for the duration of operation, wherein:
secure access includes but not limited to verifying identity tag information to gain access to the functionality of the mobile computing device.
data includes but not limited to online account usernames, online account passwords, Microsoft office files, audio files, video files, software, and other user generated digital files and information.
wireless connection can be established based on one or multiple wireless communication technologies. Examples include but not limited to near-field communication (NFC), Bluetooth, infrared, and radio frequency identification (RFID), and other future wireless connection protocols and technologies.

10. The system of claim 9, wherein the personal data storage device (PDSD) is a physically separated device that can provide both secure access and data storage or only secure access to mobile computing device (MCD).

11. The system of claim 9, wherein the personal data storage device (PDSD) can be a personal wearable item or an implant, wherein:
personal wearable item can be in physical forms of many commonly used personal wearable items, example includes but not limited to rings, pendants, bracelets, wristbands, watches.
personal wearable item can have display screen(s) and can display information related to the communication system, such as incoming calls, text messages, system status, etc.
personal wearable item can have user input mechanisms, such as buttons, keyboard, touch screen, knobs, allowing user input to the communication system through the personal data storage device (PDSD).
personal wearable item can be programmed to deliver warning signals to the owner, such as vibrating, flashing, or beeping in preprogrammed patterns. Such warning signal includes but not limited to owner-forget-phone signal, hacker-attacking signal, or low-battery signal.
personal wearable item can also be paired, provide access control to, and/or share data with multiple other devices, such as tablet, laptop computers.
physical form and location of the personal data storage device (PDSD) shall be undisclosed to third part and only known by the owner of the communication system.

12. The system of claim 9, wherein the personal data storage device (PDSD) can be powered by internal rechargeable battery, disposable battery, or passively by radio frequency, wherein:
rechargeable battery can be charged wirelessly or through a wire.

13. The system of claim 9, wherein the mobile computing device (MCD) includes but not limited to cellular phones, smart phones, tablets, laptop computers.

14. The system of claim 9, wherein the mobile computing device (MCD) can be a device designed to work with the personal data storage device (PDSD) or a compatible conventional device through software applications, wherein:
conventional compatible device refers to cellular phone, tablet computer, laptop computer that contain the required wireless communication circuitry and store data in its internal memory. Examples include but not limited to iPhone 6, Samsung Galaxy S5, Windows Phone 8X, etc.

15. The system of claim 9, wherein the mobile computing device (MCD) can have internal data storage capacity or have no internal data storage capacity.

16. The system of claim 9, wherein the mobile computing device (MCD) can be configured to store data partially or completely on the personal data storage device (PDSD).

17. The system of claim 9, wherein the mobile computing device (MCP) can be configured to cache portion of data from the personal data storage device (PDSD) to its internal storage memory to facilitate data processing. Such cached data shall be destroyed at the end of usage.

18. The system of claim 9, wherein the predetermined proximity ranges from being in physical contact to 100 meters and can be configured as a single or a tiered structure utilizing appropriate wireless circuitries. For example, the predetermined proximity can be configured as a three-tier structure: tier one is set at fifteen centimeter for the phone to accept operation commands; tier two is set at two meter for continuous functioning of the phone; tier three is set at ten meters for the ring to vibrate and signal the owner forgets his/her phone.
